(19) United States
(12) Patent Application Publication
(10) Pub. No.: US 2010/0246753 A1
(43) Pub. Date: Sep. 30, 2010

(54) Fourth Generation Computed Tomography Scanner

(75) Inventor: Ivan P. Mollov, Mountain View, CA (US)

Correspondence Address: HOUST CONSULTING (Varian), P.O.BOX 2688, SARATOGA, CA, 95070-0688, US

(73) Assignee: Varian Medical Systems, Inc., Palo Alto, CA (US)

(21) Appl. No.: 12/411,081

(22) Filed: Mar. 25, 2009

(51) Int. Cl. H05G 1/60

(52) U.S. Cl. 378/7; 378/9

(57) ABSTRACT

A computed tomography apparatus includes a gantry having a rotary portion and a stationary portion. At least one radiation source and at least one anti-scatter grid are mounted on the rotary portion of the gantry and positioned opposite each other. A detector device is mounted on the stationary portion of the gantry. The detector device may include a plurality of detector sensors arranged in the form of a generally circular ring surrounding the periphery of the rotary portion. Alternatively, the detector device may include a plurality of flat panel detectors arranged in a generally circular geometry.

### BACKGROUND

This invention relates generally to X-ray imaging and in particular to computed tomography apparatuses and methods for medical diagnostic imaging and for applications in other industries including security industry.

Computed tomography (CT) technology utilizes a plurality of X-ray views or projections made from different angles, which are taken through cross-sections or slices of an object such as a patient. X-rays from a source traverse through a slice of an object, and are received and detected by multiple detectors. The detected signals are indicative of X-ray attenuation of the slice tissue along the paths of transmission of X-rays making up a view or projection. A series of projections from various angles are acquired and reconstructed using a known algorithm to produce a CT image showing the internal anatomy of the slice of the patient.

Apparatuses and systems for computed tomography have gone through major evolutions. FIG. 1 illustrates a fourth generation (4G) CT scanner 100, which includes a rotary X-ray source 102 and a stationary, circular ring of detectors 104. In operation, the X-ray source 102 rotates around a patient 106 and transmits X-rays from various angles through a slice of the patient 106 to generate a series of projections. The circular ring of detectors 104 remains stationary during the entire scan.

While significant advances have been made in computed tomography, challenges remain. For example, in conventional fourth generation CT scanners only a small portion e.g. about 30 to 40 percent (104a) of a large array of detectors (104) are exposed at any one time in operation as shown in FIG. 1. This results in less efficient use of expensive detectors. Another issue with conventional fourth generation CT scanners is the ineffective scatter rejection, which affects image quality. Currently anti-scatter grids are used and attached to detectors in third general scanners to reduce the level of scattered radiation. However, in fourth generation scanners, detectors are stationary relative to a moving X-ray source. Because anti-scatter grids attached to stationary detectors would not remain focused to a moving X-ray source in operation, focused anti-scatter grids have not been used in fourth generation scanners.

### SUMMARY

The present invention provides X-ray imaging apparatuses and methods that are particularly useful in providing anatomic images of a patient or animals, or in detecting explosives or other objects in security or other industries. In one embodiment, a computed tomography apparatus includes a gantry having a rotary portion and a stationary portion, a radiation source mounted on the rotary portion of the gantry, a detector device mounted on the stationary portion of the gantry, and an anti-scatter grid mounted on the rotary portion of the gantry. The anti-scatter grid is preferably a focused grid. The focused grid can be planar, or curved having a substantially constant radius of curvature mounted near the periphery of the rotary portion of the gantry. The relative position between the anti-scatter grid and the radiation source is preferably fixed in operation. In some embodiments, the computed tomography apparatus may include two or more X-ray sources spaced apart. The detector device may include a plurality of detector sensors arranged in the form of a generally circular ring surrounding the periphery of the rotary portion. Alternatively, the detector device may include a plurality of flat panel detectors arranged in a generally circular geometry.

In some embodiments, a computed tomography apparatus includes a gantry having a rotary portion and a stationary portion, two or more radiation sources mounted on the rotary portion of the gantry, and a detector device mounted on the stationary portion of the gantry. In a preferred embodiment, the apparatus includes three radiation sources evenly spaced apart. The detector device may include a plurality of detector sensors arranged in the form of a generally circular ring surrounding the periphery of the rotary portion. Alternatively, the detector device may include a plurality of flat panel detectors arranged in a generally circular geometry. Preferably, two or more anti-scatter grids are mounted on the rotary portion of the gantry, and each of the anti-scatter grids is positioned opposite to one of the two or more X-ray sources. Focused grids are preferred. In some embodiments, the focused grids are curved and mounted adjacent to the periphery of the rotary portion of the gantry in close proximity to the detectors.

In some embodiments, a computed tomography apparatus includes a gantry having a rotary portion and a stationary portion, a radiation source mounted on the rotary portion of the gantry, and a plurality of flat panel detectors mounted on the stationary portion of the gantry. The flat panel detectors are preferably arranged in a generally circular geometry. Preferably, the apparatus includes a focused grid mounted on the rotary portion of the gantry and positioned opposite to the radiation source. In some embodiments, the apparatus may include two or more radiation sources mounted on the rotary portion of the gantry, and two or more focused grids mounted on the rotary portion of the gantry. Each of the two or more focused grids is positioned opposite to one of the two or more X-ray sources.

### BRIEF DESCRIPTION OF THE DRAWINGS

These and various other features and advantages will become better understood upon reading of the following detailed description in conjunction with the accompanying drawings and the appended claims provided below, where:

FIG. 1 is a schematic end view of a conventional fourth generation CT scanner;

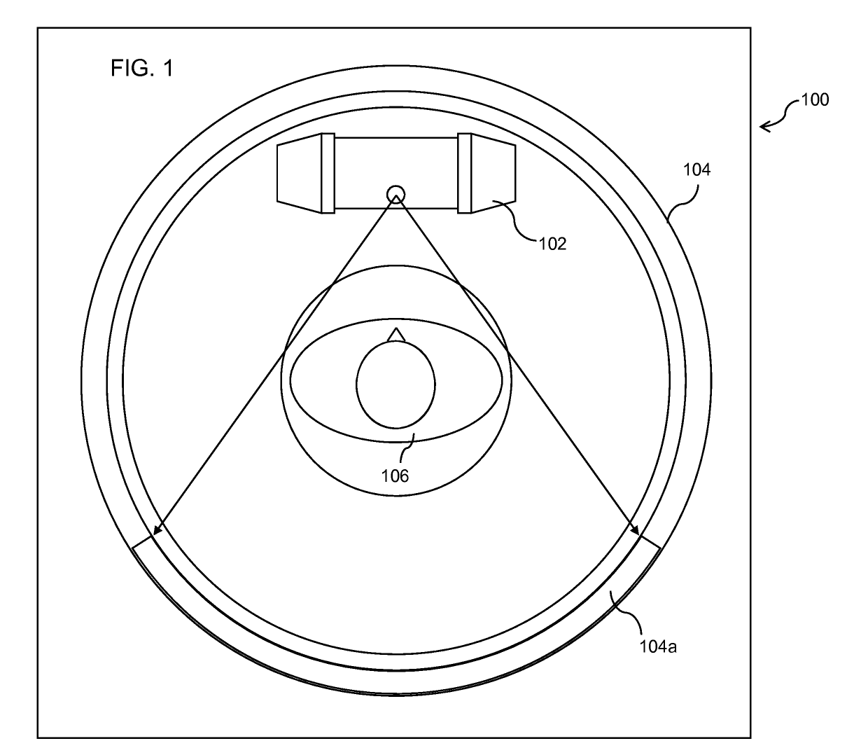

FIG. 2 is a schematic end view of a CT scanner comprising an anti-scatter grid in accordance with some embodiments of the invention;

FIG. 3 is a schematic end view of a CT scanner comprising an anti-scatter grid in accordance with some other embodiments of the invention;

FIG. 4 is a schematic end view of a CT scanner comprising multiple radiation sources and anti-scatter grids in accordance with some embodiments of the invention; and

FIG. 5 is a schematic end view of a CT scanner comprising multiple radiation sources, anti-scatter grids, and flat panel detectors in accordance with some embodiments of the invention.

### DETAILED DESCRIPTION OF VARIOUS EMBODIMENTS

Various embodiments of computed tomography apparatuses and methods are described. It is to be understood that the invention is not limited to the particular embodiments described as such may, of course, vary. An aspect described in conjunction with a particular embodiment is not necessarily limited to that embodiment and can be practiced in any other embodiments. For instance, while various embodiments are described in connection with fourth generation CT scanners, it will be appreciated that the invention can also be practiced in other imaging or radiotherapy modalities. It is also to be understood that the terminology used herein is for the purpose of describing particular embodiments only, and is not intended to be limiting since the scope of the invention will be limited only by the appended claims, along with the full scope of equivalents to which such claims are entitled.

In addition, various embodiments are described with reference to the figures. It should be noted that the figures are not drawn to scale, and are only intended to facilitate the description of specific embodiments. They are not intended as an exhaustive description or as a limitation on the scope of the invention.

All technical and scientific terms used herein have the same meaning as commonly understood by one of ordinary skill in the art to which this invention belongs, unless defined otherwise. As used in the description and appended claims, the singular forms of “a,” “an,” and “the” include plural references unless the context clearly dictates otherwise. Thus, for example, reference to “a radiation source” includes one or more radiation sources, and reference to “the detector” includes one or more detectors of the kind described herein.

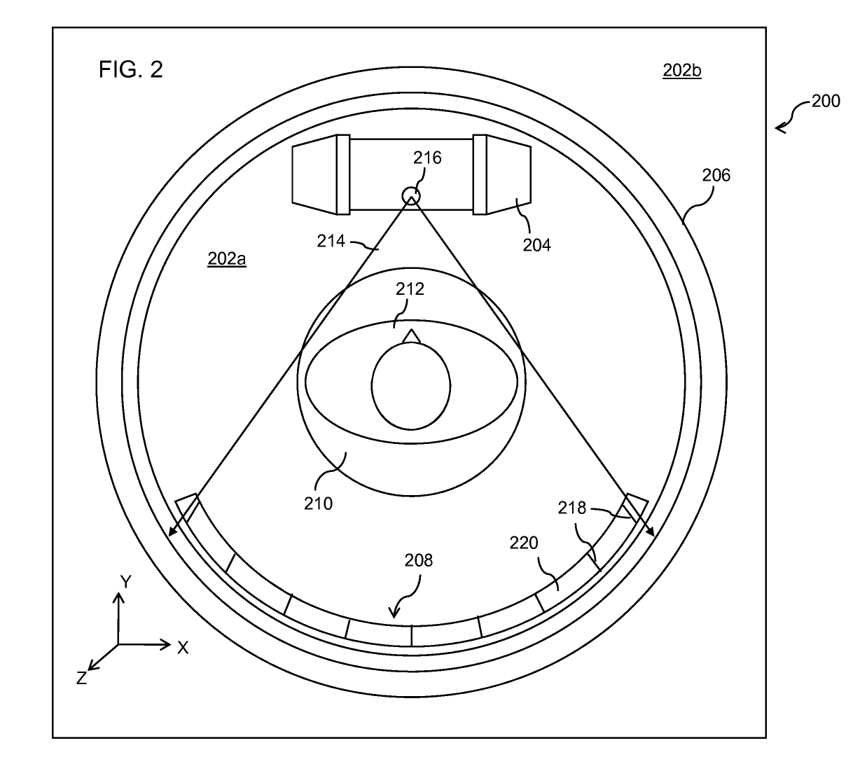

FIG. 2 illustrates an exemplary CT scanner 200 in accordance with some embodiments of the invention. In general, the CT scanner 200 includes a gantry 202 having a rotary portion 202a and stationary portion 202b. Clearance is provided between the rotary portion 202a and the stationary portion 202b. A radiation source such as an X-ray tube 204 is mounted on the rotary portion 202a. A detector system such as a circular ring or rings of detectors 206 is mounted on the stationary portion 202b. An anti-scatter grid 208 is mounted on the rotary portion 202a opposite to the radiation source 204.

The rotary portion 202a is generally an annular shaped frame housing the radiation source 204. The rotary portion 202a is provided with an opening 210 to allow a structure (not shown) supporting an object to be imaged such as a patient 212 passing through. The rotary portion 202a is rotatable about an axis (e.g. Z-axis). The supporting structure is movable along the Z-axis. For example, the supporting structure is operable to be incremented along the Z-axis to allow generation of projections of a plurality of parallel slices. In some embodiments, the supporting structure may be continuously translated along the Z-axis during the scan. A combination of continuous translation of the supporting structure and simultaneous rotation of the radiation source creates a spiral or helical trajectory of radiation beams with respect to the object to be imaged.

The radiation source 204 may be configured to generate fan-shaped beams, or fan beams 214, of X-rays that emanate from a focal spot 216. The fan beams of X-rays 214 pass through the object 212 being imaged, and are received by the detector system 206. The fan beam 214 is defined by the volume space between the focal spot 216 and the receiving surfaces of the detector elements of the detector system 206 exposed to the beam. A collimator such as an adjustable collimator (not shown) may be used to control the fan beam 214 such as the beam angle and beam width. Preferably the fan angle of the beam 214 is sufficiently large to interrogate an entire cross-section of the object 212 to be imaged. Alternatively, the fan beam angle may be restricted to interrogate only a region of interest within the object 212. The width of the fan beam 214 may be controlled for either single-slice scanning or multiple-slice scanning.

The detector system or device 206 is mounted on the stationary portion 202b of the gantry 202, and hence it does not move when the radiation source 204 rotates around the object 212. The detector system 206 may be arranged in a fixed ring frame or the like surrounding the periphery of the rotary portion 202a. The detector system 206 may be a detector array adapted to measure the intensity of radiation passing through a single section or slice of the object 212. The detector system 206 may also be multiple detector arrays including a set of several detector arrays adapted to measure the intensity of radiation passing through multiple sections or slices of the object 212. The detector system 206 may include a plurality of detector elements each comprising e.g., a scintillator and a photodetector or other radiation-sensitive detector. The scintillator emits visible light when it is struck by X-rays. The light emitted by the scintillator reaches the photodetector e.g. a photodiode or the like, which converts the light intensity to an electrical signal proportional to the light intensity. In some embodiments, the detector elements may include photoconductive materials that produce hole-electron pairs directly when X-rays are absorbed. The plurality of detector elements may be arranged in a full circle to cover an angular range of 360 degrees around the object 212. Alternatively, the detector elements may be arranged in a partial circle to cover an annular range of less than 360 degrees, such as e.g. 180° degree or greater around the object 212. In some preferred embodiments, the detector elements may be arranged in multiple adjacent rings or rows such as e.g. 32 rows, 64 rows, or more.

The anti-scatter grid 208 is preferably mounted on the rotary portion 202a of gantry 202. The grid 208 is positioned opposite to the radiation source 204 across the opening 210. The grid 208 is preferably in a fixed position relative to the radiation source 204 and rotates together with the radiation source 204 in operation.

The anti-scatter grid 208 is provided to reduce the level of scattered radiation received by the detector system 206. Radiation scattering occurs when incident radiations such as X-rays interact with the object being imaged. Scattered radiations pass through the object with an angle significantly deviating from its original incident path and are of no diagnostic value since the recorded signals do not relate to the anatomy of the object or patient. Scattered radiations cause artifacts and reduce contrast in reconstructed CT images. Anti-scatter grids are effective devices that reduce the level of scattered radiations arriving at the detectors. The anti-scatter grid 208 includes a series of members or strips 218 of radiation absorbent material (grid material) alternating with sections 220 of radiolucent material (inter-space material). The grid 208 is designed to transmit those radiations whose direction is on a straight line from the radiation source 204 to the detector sensors 206. Scattered radiations that travel obliquely are generally absorbed in the grid material.

Various anti-scatter grids are known in the art and can be used in various embodiments of the invention. Suitable grid materials include dense elements or alloys having a high atomic number such as e.g. lead, tungsten, tantalum, uranium, thorium, iridium, gold, and their alloys etc. Suitable interspace materials include elements or composites with a low atomic number such as e.g. aluminum, beryllium, plastics such as methacrylate plastics, carbon fiber composites, solid foams of various materials, or aerogels etc. The grid ratio (the height of the grid strip divided by the thickness of the interspace material), grid frequency (the number of grid strips per inch or centimeter), and other grid parameters can be optimized to enhance the performance of the grid 208.

Preferably the anti-scatter grid 208 is a focused grid. A focused grid 208 has a geometric pattern in which the grid members or strips 218 are arranged generally parallel to the radiation beams 214 emanating from the focal spot 216. For example, the grid strips 218 can be tilted so that if they were extended, the grid strips 218 would intersect along an imaginary convergence line at the X-ray source focal spot.

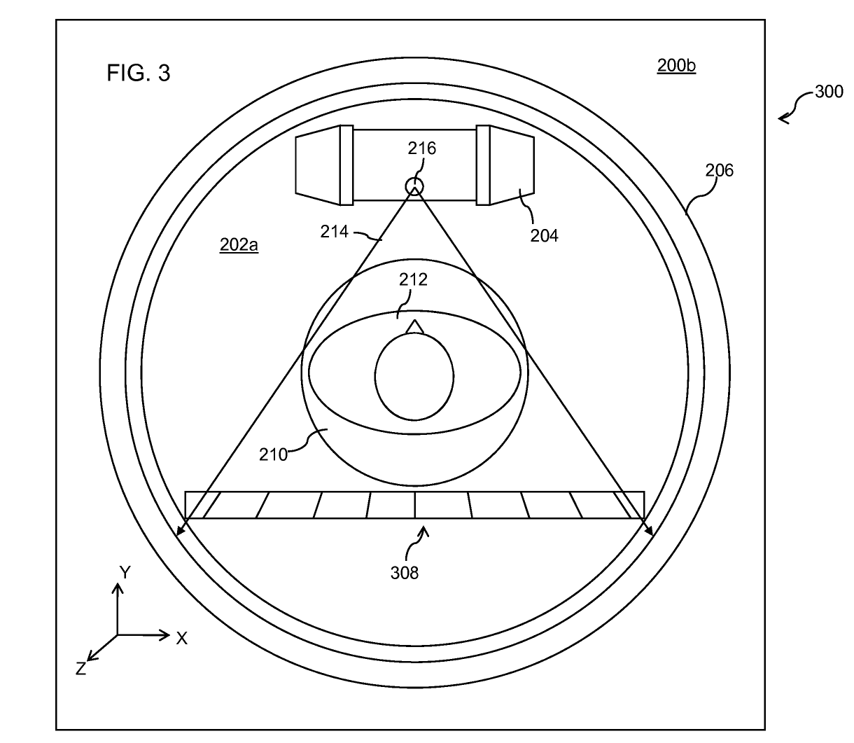

The grid 208 may have a curved surface (FIG. 2). The radius of the curvature to the center of rotation of the gantry may be generally constant. A curved grid 208 may be advantageous in that it can be mounted near or along the periphery of the rotary portion 202a of gantry 202, and hence near the detector system 206. The close proximity between the grid 208 and the detector system 206 may more effectively reduce the level of scattered radiations received by the detector system 206. Alternatively, the grid 308 may be planar (FIG. 3) which can be more easily manufactured. A planar grid 308 may be mounted on the rotary portion 202a of gantry 202 near the opening 210 or the object 212. This may be desirable to coordinate with a fan beam with a large fan angle.

A system control (not shown) may include various circuits coupled to various components for controlling the operation of the CT scanner 200 or 300. For example, a power supply circuit provides power and timing signals to the radiation source 204. A rotation circuit controls the rotation speed and position of the rotary portion 202a of gantry 202. A motor circuit controls the movement and position of the supporting structure, etc. A data acquisition circuit acquires signals detected by the detector system 206, which may be digitized using e.g. an analog-to-digital (A/D) conversion circuit known in the art. A reconstruction circuit or a computer reconstructs the digitized data using algorithms known in the art to produce CT images, which may be stored in a memory circuit, and shown on a display.

In operation, an object such as a patient 212 is placed on the supporting structure which is movable along the Z-axis of the CT scanner 200 or 300. After the patient 212 is properly positioned in the CT scanner, the radiation source 204 is activated to generate radiation beams of e.g. X-rays. A fan beam 214 emanating from the focal spot 216 is transmitted transversely through a sectional slice of the object 212. A fixed or an adjustable collimator may be used to control the fan beam so that the beam is sufficiently wide to interrogate an entire cross-section of the object 212 or narrow to interrogate a restricted region of interest within the object 212. Scattered radiations deviating from the original transmission path of the beam are blocked by the grid 208 or 308 from reaching the detector system 206. Radiations that pass though the grid 208 or 308 are received and detected by the detector system 206. The detected signals are acquired by the data acquisition system, processed and stored.

The rotary portion 202a of gantry 200 rotates to position the radiation source 204 at different angles to generate successive projections of the slice. Because the anti-scatter grid 208 or 308 is also mounted on the rotary portion 204 of gantry 200, the position of the grid 208 or 308 relative to the radiation source 204 is fixed during the rotation of the rotary portion 202a. Therefore, a focus grid 208 or 308 may remain focused during the entire scan, and as a result, the level of scattered radiation received by the detection system 206 is substantially reduced or eliminated.

The rotation may be a full rotation in 360 degrees or a partial rotation less than 360 degrees such as e.g. 180 degrees plus a fan angle. In general, 500-600 projections for a slice are acquired for reconstruction of CT images. Reconstruction algorithms such as backprojection reconstruction algorithms are known in the art.

To generate projection data for a next sectional slice of the object 212, the supporting structure may be incremented along the Z-axis to expose the next slice to the path of the fan beam. The process described above is repeated to generate a series of projections of the next slice. The incremental movement of the supporting structure and the scanning process are repeated as long as more slices are needed. The scanning process generates projection data sets for a plurality of slices in parallel. Alternatively, projection data for multiple slices may be generated using a spiral or helical pattern in which the object 212 is continuously scanned while the radiation source 204 rotates about the object 212 and the supporting structure is translated along the Z-axis simultaneously with the rotation of the radiation source 204. Slip ring construction or other suitable means may be used to enable continuous multiple rotations of the radiation source 204.

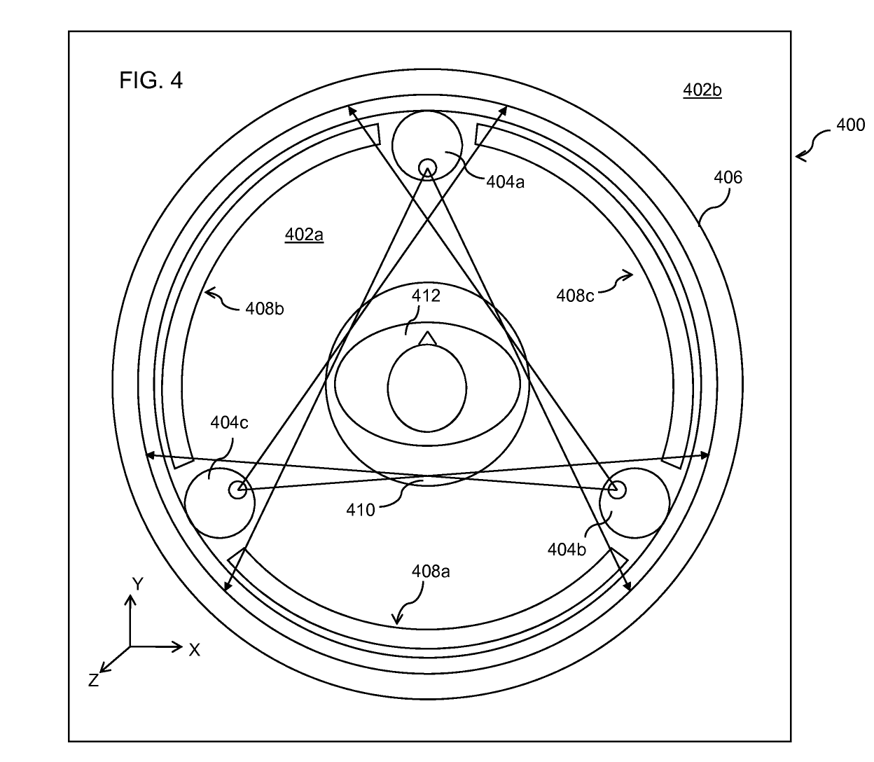

FIG. 4 illustrates another exemplary CT scanner 400 in accordance with some embodiments. The CT scanner 400 is similar in many aspects to scanner 200 illustrated in FIG. 2. For example, the CT scanner 400 includes a gantry 402 having a rotary portion 402a and a stationary portion 402b. A detector array or multiple detector arrays 406 is (are) mounted on the stationary portion 402b. The rotary portion 402a has an opening 410 to allow a structure (not shown) supporting an object to be imaged such as a patient 412 passing through. The rotary portion 402a is rotatable around the Z-axis. The supporting structure is movable along the Z-axis. The supporting structure is operable to be incremented along the Z-axis to allow generation of a series of projections for parallel slices. Alternatively, the supporting structure is operable to be continuously moved along the Z-axis simultaneously with the rotation of the radiation source 404 to generate a series of projections for multiple slices in a spiral pattern.

In comparison with the CT scanner 200 illustrated in FIG. 2, the CT scanner 400 in FIG. 4 includes more than one radiation source mounted on the rotary portion 402a of gantry 402. FIG. 4 illustrates three radiation sources 404a, 404b, 404c spaced apart, or evenly spaced apart. It should be appreciated that two or more than three radiation sources may be mounted on the rotary portion 402a. Each of the multiple radiation sources 404a, 404b, 404c may be configured to generate fan-shaped beams. The fan angles of the beams may be sufficiently large to allow the fan beam to interrogate an entire cross section of the object 412, or narrow to interrogate a restricted region of interest in the object 412. The width of the fan beam may also be collimated to traverse a single slice or multiple slices of the object 412 simultaneously.

More than one anti-scatter grid may be mounted on the rotary portion 402a of gantry 402. For illustration purpose, three grids 408a, 408b, 408c are shown in FIG. 4, each being positioned opposite to one of the three radiation sources 404a, 404b, 404c across the opening 410. It should be appreciated that the number of grids may be different from three depending on the number of the radiation sources used. The grids 408a, 408b, 408c are preferably focused grids. The grids 408a, 408b, 408c may be curved, or have a substantially constant radius of curvature to the axis of rotation of the gantry. Alternatively, the grids may be planar.

In operation, the more than one radiation sources 404a, 404b, 404c may simultaneously transmit fan beams to a slice or multiple slices in the object 412. Radiations from the more than one radiation sources 404a, 404b, 404c, which have traversed the object 412 and the more than one anti-scatter grids 408a, 408b, 408c may be detected simultaneously. Data obtained from radiations emitted by different radiation sources detected at a same rotation angle may be averaged and used in reconstruction of CT images. The use of multiple radiation sources may advantageously speed up data acquisition and reduce scanning time proportionally. For example, if three radiation sources are used simultaneously, then a partial rotation of the rotary portion 402a (e.g., ⅓ of full rotation) would be sufficient to acquire projection data from angles in 360 degrees. The use of multiple radiation sources may also advantageously increase the usage of a circular ring or rings of detector sensors 406. For example, more than 80 percent of the detector sensors 406 may be exposed at any one time in operation, which is a significant increase from 30 to 40 percent in the prior art.

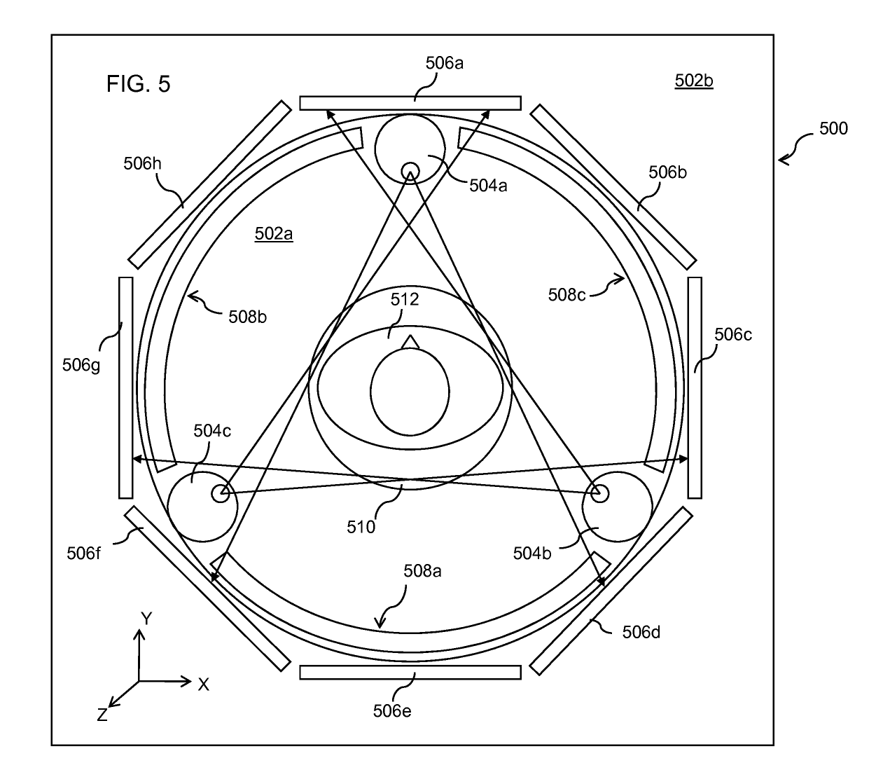

FIG. 5 illustrates another exemplary CT scanner 500 in accordance with some embodiments. The CT scanner 500 is similar in many aspects to scanner 400 illustrated in FIG. 4. For example, the CT scanner 500 includes a gantry 502 having a rotary portion 502a and a stationary portion 502b. Multiple radiation sources 504a, 504b, 504c are mounted on the rotary portion 502a of gantry 502. Each of the multiple sources 504a, 504b, 504c may be configured to generate fan-shaped beams sufficiently wide to interrogate an entire cross section of the object 512, or narrow to interrogate a restricted region of interest in the object 512. Multiple anti-scatter grids 508a, 508b, 508c are mounted on the rotary portion 502a of gantry 502, each being positioned opposite to one of the multiple sources 504a, 504b, 504c across the opening 510. The anti-scatter grids 508a, 508b, 508c are preferably focused grids.

In comparison to the CT scanner 400 illustrated in FIG. 4 which includes a circular ring or rings of detector array(s) 406, the CT scanner 500 in FIG. 5 includes a plurality of flat panel detectors (FPDs) 506a, 506b, 506c, 506d, 506e, 506f, 506g, 506h mounted on the stationary portion 502b of gantry 502. Preferably the plurality of flat panel detectors 506a . . . 506h are positioned in close proximity to each other to form a generally circular geometry. Eight flat panel detectors are shown in FIG. 5, and it should be appreciated that fewer or more than eight flat panel detectors may be used. One or more detectors may receive and detect radiations emitted by a particular radiation source, which have passed through the object 512 and an anti-scatter grid.

Suitable flat panel detectors include a radiation-converting material, a sensor panel, analog and digital electronics, and other control and processing electronics. Various radiation-converting materials and methods can be used to convert incoming radiations into charge for electronic readout. In some embodiments, photoconductive materials can be used to produce hole-electron pairs directly when radiations are absorbed. In some embodiments, scintillator materials are used to convert the energy of radiation to visible light, which is then converted to electrical signals by photodetective materials. The sensor panel accumulates charge generated by the absorption of radiation and provides the charge row by row during scanning to charge amplifiers. The charge storage device can be capacitors in photoconductor imagers or a photodiode in panels used with scintillators. Various switches including e.g. single diodes, diode pairs or thin-film transistors may be used to permit the charge to flow out. In some embodiments, the storage devices include thin film transistors.

The use of flat panel detectors is advantageous. FPDs provide large detection areas to generate images over a large object or a large region of interest in an object, and improve dose utilization. FPDs are more robust, have a longer service life, and can be manufactured in more cost effective methods.

Exemplary embodiments of fourth generation CT scanners with improved performance have been described. The CT scanner advantageously employs an anti-scatter grid to reduce scattered radiations received on a detector device, thereby greatly improving the image contrast of reconstructed images. The use of multiple radiation sources significantly speeds up the scanning of CT scanners and increases the efficient use of expensive detectors. The use of flat panel detectors greatly reduces the cost of CT scanners.

Those skilled in the art will appreciate that various modifications may be made within the spirit and scope of the invention. All these or other variations and modifications are contemplated by the inventors and within the scope of the invention.

What is claimed is:

1. A computed tomography apparatus comprising:
a gantry having a rotary portion and a stationary portion;
a radiation source mounted on the rotary portion of the gantry;
a detector device mounted on the stationary portion of the gantry; and
an anti-scatter grid mounted on the rotary portion of the gantry.

2. The computed tomography apparatus of claim 1 wherein said anti-scatter grid comprises a focused grid.

3. The computed tomography apparatus of claim 2 wherein said focused grid is generally planar.

4. The computed tomography apparatus of claim 2 wherein said focused grid is curved.

5. The computed tomography apparatus of claim 4 wherein said focused grid has a substantially constant radius of curvature and is mounted near the periphery of the rotary portion of the gantry.

6. The computed tomography of claim 1 wherein the relative position between said anti-scatter grid and said radiation source is fixed.

7. The computed tomography apparatus of claim 1 which comprises two or more radiation sources spaced apart.

8. The computed tomography apparatus of claim 1 wherein said detector device comprises a plurality of detector sensors arranged in the form of a generally circular ring or rings surrounding the periphery of the rotary portion.

9. The computed tomography apparatus of claim 1 wherein said detector device comprises a plurality of flat panel detectors.

10. A computed tomography apparatus comprising:
a gantry having a rotary portion and a stationary portion;
two or more radiation sources mounted on the rotary portion of the gantry; and
a detector device mounted on the stationary portion of the gantry.

11. The computed tomography apparatus of claim 10 which comprises three radiation sources generally evenly spaced apart.

12. The computed tomography apparatus of claim 10 wherein said detector device comprises a plurality of detector sensors arranged in the form of a generally circular ring or rings surrounding the periphery of the rotary portion.

13. The computed tomography apparatus of claim 10 wherein said detector device comprises a plurality of flat panel detectors.

14. The computed tomography apparatus of claim 10 further comprising two or more anti-scatter grids mounted on the rotary portion of the gantry each being positioned opposite to one of the two or more radiation sources.

15. The computed tomography apparatus of claim 14 wherein said two or more anti-scatter grids comprise a focused grid.

16. The computed tomography apparatus of claim 15 wherein said focused grid is curved and mounted adjacent to the periphery of the rotary portion of the gantry.

17. A computed tomography apparatus comprising:
a gantry having a rotary portion and a stationary portion;
a radiation source mounted on the rotary portion of the gantry; and
a plurality of flat panel detectors mounted on the stationary portion of the gantry.

18. The computed tomography apparatus of claim 17 wherein said plurality of flat panel detectors are arranged in a generally circular geometry.

19. The computed tomography apparatus of claim 17 further comprising a focused grid mounted on the rotary portion of the gantry.

20. The computed tomography apparatus of claim 17 which comprises two or more radiation sources mounted on the rotary portion of the gantry, and two or more focused grids mounted on the rotary portion of the gantry each being positioned opposite to one of the two or more radiation sources.
